(19) United States
(12) Patent Application Publication
(10) Pub. No.: US 2004/0190164 A1
(43) Pub. Date: Sep. 30, 2004

(54) Lens mount

(76) Inventor: Joseph R. Bentley, West Jordan, UT (US)

Correspondence Address: Michael L. Smith, Bausch & Lomb Incorporated, One Bausch & Lomb Place, Rochester, NY, 14604-2701, US

(21) Appl. No.: 10/403,183

(22) Filed: Mar. 28, 2003

(51) Int. Cl. G02B 7/02

(52) U.S. Cl. 359/819

(57) ABSTRACT

A lens mount 10 includes a base 12 and a housing 14 for holding a lens in a fixed position. A spring 16 is integrally formed between the base 12 and housing 14 for providing resilient support to the housing 14.

### BACKGROUND OF THE INVENTION

1. Field of the Invention

The present invention is directed to optical holders or mounts and in particular, precision mounts for use in laser ophthalmic diagnostic equipment.

2. Description of Related Art

Accurate and highly stable lens mounts are known in the prior art. These systems typically are composed of many separate parts all interacting together to move the lens to the precise location required and to then to maintain the lens in that location. Typically, these mounts have several screw-type mechanisms to move the mount in various amounts along the x-y-z axis in three-dimensional space.

However, prior art adjustable lens mounts are typically expensive to manufacture and somewhat difficult to assemble because of their many separate parts. Therefore, it is desirable to have a lens mount, which is integrally formed and thereby easy to manufacture, less expensive than the prior art, and easier to assemble.

### BRIEF DESCRIPTION OF DRAWINGS

FIG. 1 shows a front view of a mount in accordance with the present invention;

FIG. 2 shows a side view of the mount of FIG. 1, taken along line 2-2;

FIG. 3 is a front view of a fully assembled lens mount in accordance with the present invention;

FIG. 4 is a side view of the mount of FIG. 3; and

FIG. 5 is a top view of the lens mount of FIG. 4.

### DETAILED DESCRIPTION OF THE PREFERRED EMBODIMENT

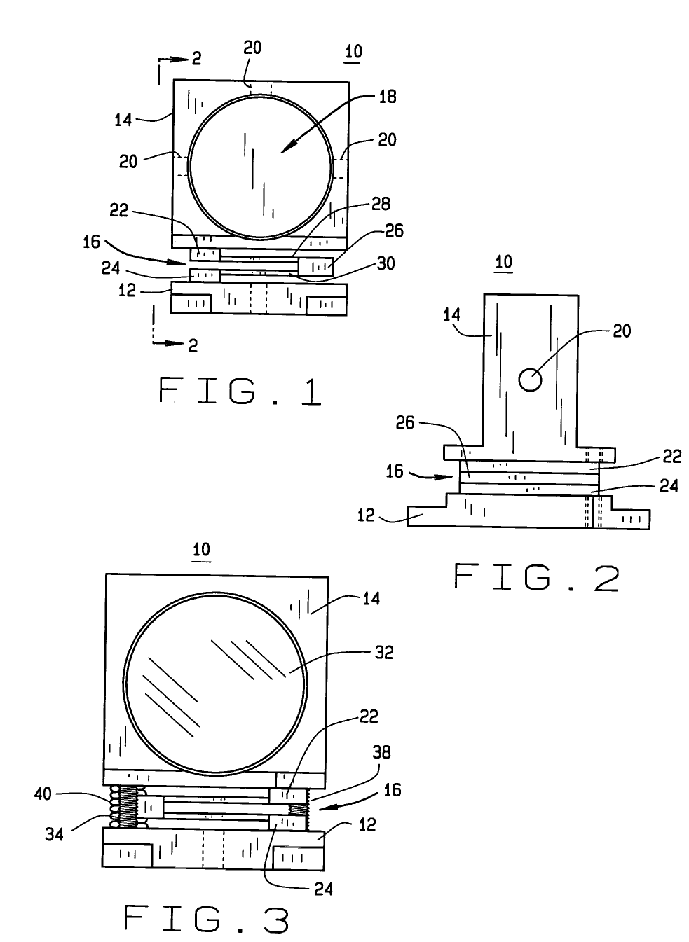

FIG. 1 shows a lens mount 10 having a base 12, a housing 14 for holding a lens in a fixed position and a spring 16 integrally formed between the base 12 and the housing 14 for providing resilient support to the housing 14. In use, a lens is mounted in the space shown at 18 and is held in place within housing 14 through the application of a suitable adhesive, which is applied through holes 20.

Spring 16 preferably includes at least top and bottom spring blocks 22 and 24, respectfully. Blocks 22 and 24 are connected to spring block 26 via interconnecting arms 28 and 30. Spring 16 is preferably integrally formed with base 12 and housing 14 of aircraft grade aluminum alloy such as 7075-T6 or other suitable material, which can be molded or machined. Obviously, spring 16 could be attached between base 12 and housing 14 via screws, adhesive, or other materials and spring 16 could also be formed by connecting together each of the individual parts described above at reference numbers 22-30. However, the use of several individual parts significantly increases the difficulty and cost of manufacture.

FIG. 2 shows a side view of mount 10 showing the housing 14, the base 12, and the spring 16 formed there between.

FIG. 3 shows a fully assembled lens mount, in accordance with the present invention including housing 14, base 12, and spring 16. In addition, a lens 32 is shown within housing 14. Lens mount 10 preferably further includes at least three alignment screws 34, 36, and 38, with alignment screw 36 surrounded by a biasing spring 40. The alignment screws 34, 36, and 38 surrounding the housing 14 are adjustably attached to the housing 14 and to the base 12 to allow the lens 32 to be accurately positioned within an optical system, such as an ophthalmic diagnostic system which relies on directing laser or other light onto a patient's eye.

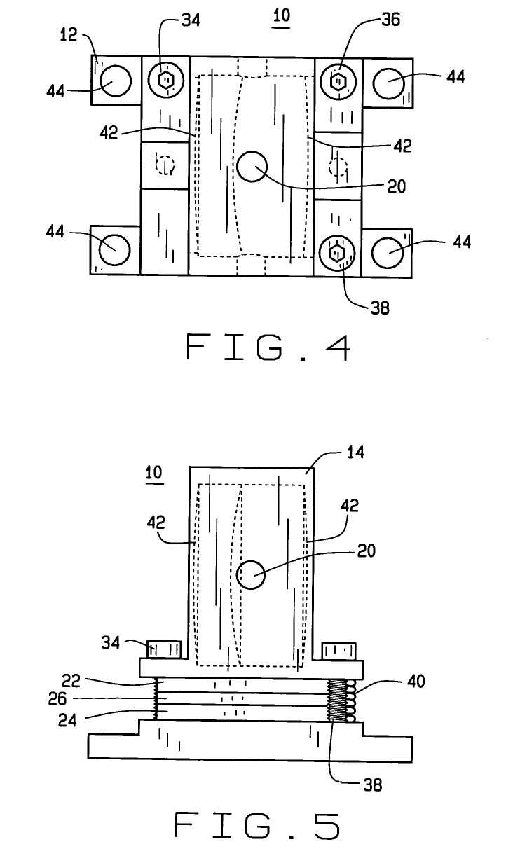

By use of the biasing spring 40 and manipulation of the alignment screws 34-38 the spring 16 can be compressed, expanded, and bent to move the lens 32 radially into the proper position within the optical system in which it is used. Dashed lines 42 of FIGS. 4 and 5 represent the features of a custom achromat lens 32. It is noted that in FIG. 5, the lines running horizontally near the top and bottom of this view are stepped on the left side to assist in placing the lens in its correct axial position.

FIG. 5 shows a top view of FIG. 4 and the lens mount moves in a plane which is normal to the optical axis according to the adjustments made to the alignment screws 34, 36, and 38. Base 12 also includes attachment through holes 44 for attaching the mount 10 to a chassis or other substrate within the larger diagnostic instrument in which mount 10 is to be used.

As can be seen from the above description, the lens mount of the present invention has very few separate parts and can be easily adjusted by the three alignment screws to properly align the lens 32 to accommodate the necessary optical path. Thus permitting the proper positioning of an image or light beam for use in a larger system by simply adjusting the three alignment screws. In this way, a cost effective, reliable, and precise lens mount 10 has been achieved wherein the main portion is manufactured from a single integral piece of material.

We claim:

1. A lens mount comprising:
a base
a housing for holding a lens in a fixed position; and
a spring integrally formed between the base and the housing for providing resilient support to the housing.

2. The mount of claim 1 further including at least 3 alignment screws surrounding the housing and adjustably attached to the housing and the base.

3. The mount of claim 2 further including a biasing spring surrounding one of the alignment screws and located between the housing and the base.

4. The mount of claim 1 wherein the mount is molded as a unitary device.

5. The mount of claim 1 wherein the mount is machined as a unitary device.

6. The mount of claim 1 further including a lens held within the housing.
